(19) United States
(12) Patent Application Publication
(10) Pub. No.: US 2012/0065102 A1
(43) Pub. Date: Mar. 15, 2012

(54) METHOD FOR ANALYSIS OF NEURITE GROWTH

(75) Inventors: Jonathan WEST, Dortmund (DE); Jean-Philippe FRIMAT, Enschede (NL); Julia SISNAISKE, Recklinghausen (DE); Jan HENGSTLER, Dortmund (DE); Christoph VAN THRIEL, Bottrop (DE)

(73) Assignees: Forschungsgesellschaft fuer Arbeitsphysiologie und Arbeitsschutz e. V., Dortmund (DE); Leibniz - Institut fuer Analytische Wissenschaften ISAS - e. V., Dortmund (DE)

(21) Appl. No.: 13/298,433

(22) Filed: Nov. 17, 2011

Related U.S. Application Data
(63) Continuation of application No. PCT/EP2010/002811, filed on May 7, 2010.

(30) Foreign Application Priority Data
May 19, 2009 (DE) 10 2009 021 876.9
Oct. 14, 2009 (EP) 09012960.2

(51) Int. Cl. C40B 30/06

(52) U.S. Cl. 506/10

(57) ABSTRACT

A method for the analysis of neurite growth is described, in which a substrate having an array pattern is provided, which has first regions on which neurons and cells similar to neurons can adhere, whereby the first regions are surrounded by second regions, in each instance, on which neurons and cells similar to neurons cannot adhere, whereby neurons or cells similar to neurons adhere only on the first regions of the array, and subsequently, the neurons or cells similar to neurons are exposed to one or multiple or no treatment(s), and during this/these treatment(s) and/or afterwards, the neurite outgrowths from the neurons or cells similar to neurons are analyzed by recognizing and quantifying the connections that are formed between the first regions by means of the neurite outgrowths.

The invention relates to a method for the analysis of neurite growth.

In biology, cell structures that possess the capability of connecting brain cells with one another are called neurites. In the following, a neurite refers to the following:

Neurites, axons, dendrites, intermediary segments, terminal segments, filipodia and/or growth cones. The term “neural cell” comprises the plurality of the cells of the nerve system of humans, mice, other mammals, as well as the cells of the nervous system that are of non-mammalian origin.

The functional integrity of the nervous system is guaranteed, on the one hand, by means of different types of nerve cells (for example neurons, glial cells), and, on the other hand, by the interaction between these different cells. The structural and functional units of interconnection are neurites, which transport the data from one neuron to the other. These networks or circuits are highly adaptive, and new connections are made almost continuously by neurites, both in the developing brain and the adult brain. Exogenic influences on the cells by means of foreign substances, such as chemicals in the environment, medications, chemical work substances, or illegal drugs, among others, as well as physical influences, such as electromagnetic radiation, among others, can either promote the process of interconnection (neurogeneration) or inhibit it (neurotoxicity). In many areas of research (for example neurotoxicology, neurobiology, developmental biology, regenerative medicine) and also for different industrial applications (for example drug development, regulatory toxicology), reliable tools and screening methods are needed, in order to detect such effects in a standardized environment.

In this context, analysis of neurite growth plays an important role. So-called “neurite outgrowth assays” detect the formation of neurites as potential precursors of neuronal connections in the nerve system. These measurement methods are used in many different ways, because they are simple to handle and lead to relatively low material costs.

Neurite growth can be measured on the basis of the number, length, or branching (or other measures of neurite complexity) of the neurites at a certain point in time, or by means of the neurite growth rate. A neurite growth index can then be determined from these measurements. For efficient development of the chemical lead structure (lead) to the drug (drug-lead discovery), these methods can be utilized in parallel by means of the use of robot technology and microtiter plates, and thus the products can be investigated using high-throughput methods.

In the current neurite outgrowth assay state of the art the cells are cultured in a randomly distributed manner, and special coordinates that support the identification of neurites are absent. As a result, highly specific stains are generally necessary in order to visualize the neurites. Thus, for example, a selective neurite marker (expensive antibody) is available, and the company Millipore Corporation, Massachusetts, USA, sells a so-called “Assay Kit” that marks neurites, in order to analyze them by means of automated image processing, using a high-throughput process. In these techniques, the distance between adjacent cells varies greatly. On the one hand, the cells that touch one another are too close to one another; on the other hand, cells are separated from one another by great distances, so that different gradients for soluble factors that regulate neurite growth are present. These distance differences make it difficult to recognize substance-induced behavioral changes of the cells. In order to overcome this problem, comprehensive image acquisitions, in combination with pattern recognition algorithms and statistical procedures, are required.

These methods require great effort and might lead to the result that significant effects in the behavior of the interacting cells, which could give additional information about the effect of the test substance, are overlooked. A method of the type described is known, for example, from DE 600 23 905 T2.

A method is known from US 2002/0072074 A1, in which neurons are cultivated on a substrate having an array pattern, and their neurite outgrowths are analyzed. In this connection, cells accumulate on first regions coated with peptides, but not on second regions that surround the first regions. The cells are subsequently exposed to one, more than one, or no test substance. The substrate has first regions of a standardized size and position, which can be disposed in equidistant manner. The arrangement can then be in a hexagonal or linear pattern. Because the neurite outgrowths of every individual cell are monitored and analyzed, but the connections that form are not, this analysis method is also very complicated.

In contrast, it is the task of the invention to create a simple but effective possibility for analyzing neurite formation or neurite growth.

This task is accomplished by means of a method for analysis of neurite growth in which a substrate having an array pattern is made available, which substrate has first regions having a standardized size and position, on which neurons and cells similar to neurons can accumulate, whereby the first regions are surrounded by second regions, in each instance, on which neurons and cells similar to neurons cannot accumulate, whereby neurons or cells similar to neurons accumulate only on the first regions of the substrate, and subsequently, the neurons or cells similar to neurons are exposed to one or multiple or no treatment(s), and during this/these treatment(s) and/or afterwards, the neurite outgrowths from the neurons or cells similar to neurons are analyzed, by recognizing and quantifying connections that are formed between the first regions by means of the neurite outgrowths.

The invention is based on the use of cell patterning techniques, in order to provide a spatially standardized assay for measuring neurite growth during the period of action of a treatment (for example of test substances). For this purpose, substrates are used that have an array pattern with first and second regions, whereby the first regions provide locations for the neurons or cells similar to neurons to adhere, and the second regions that surround these first regions are configured in such a manner that the adhesion of neurons or cells similar to neurons is not possible.

In this context, a substrate is used, in each instance, that has first regions having a standardized size and position, thereby resulting in two great advantages:

For one thing, homogeneous gradients of soluble factors that are involved in the formation of the neurite outgrowths are formed, and, for another, neurite outgrowths can be observed without staining steps. In order to obtain statistically reliable results, a large number of nerve cells and their neurite outgrowths must be measured, and the neurite connections must be counted. Cell patterning techniques are suitable for this problem, in that they make available highly parallel test systems in the form of substrates having an array pattern (cell arrays) with hundreds of locations for the selective adhesion of neurons. Each of these locations (first regions) can contain one or more nerve cells, whereby according to the invention, the connection between first regions that forms by means of neurite outgrowths, in each instance, represents the object of the measurement, not connections within first regions.

On the basis of the standardized arrangement of the first regions (adhesion locations), with previously defined distances of the same relative to one another, the connections that form by means of the neurite outgrowths, or their lengths, respectively, between the first regions, are also standardized. The neurite outgrowth lengths are also standardized by means of this standardized arrangement, thereby making length measurements unnecessary. The distance between the first regions is selected in such a manner, in this connection, so as to meet standard neurite classification criteria. Accordingly, a neurite outgrowth is defined as a process having a length greater than or equal to one or more cell body diameters. This criterion is guaranteed by means of the array dimensions.

As an essential difference from previous methods according to the state of the art, is that the neurite outgrowths are not analyzed as such, but rather the connections that form between the first regions by means of the neurite outgrowths are measured and quantified. The number of connections that form is a significantly higher functional indicator than the analysis of the neurite outgrowths alone. Quantitative measurements of the neurite outgrowths are, of course, also valuable, but require detailed length measurements, so that an “outgrowth” can be classified as a neurite. According to the invention, only the connections that form between the first regions can be quantified by means of the standardization of the arrangement of the first regions on the substrate. This quantification can preferably be undertaken by counting the number of connections that form between the first regions. In this context, the method also allows for the simple quantification of the neurites, by means of standardized distances, because the classification criterion is automatically met when a connection between first regions exists. This can be done both manually, but preferably also automatically, by means of automated image processing techniques and analyses. As a result, “high-content” screening of neuroactive substances is made possible.

Preferably, it is provided that for treatment of the neurons or cells similar to neurons, these are exposed to one or more test substance(s) and/or test condition(s). Test conditions are also understood to be physical influences, such as different types of radiation (for example gamma radiation (radiation therapy), electromagnetic radiation (WLAN, UMTS, etc.), ¹³¹iodine radiation (beta emitters)), other treatments, such as pH changes, or other interventions in the environment, as well as temperature changes and the like. Degeneration or regeneration. or induction or inhibition of neurite growth can be investigated by means of the application time point of one, more, or no test substance(s) and/or the type of test conditions.

Cells that detach from the first regions are no longer viable. If the occupancy of the cell array changes under the effect of a test substance after a certain period of time, this change can be used as a measure of cytotoxicity. This parameter significantly supplements neurotoxicity measurements. The change in the occupancy of the cell array can be determined, in a simple manner, in that the number of occupied first regions before and after a treatment (for example, the period of action of a test substance) is counted.

Preferably, the first regions are spaced equidistantly apart from one another and/or positioned in a hexagonal pattern, in order to make available equal distances between all the adjacent cell adhesion locations (first regions). Alternatively, the first regions can also be positioned in a linear pattern. The first regions are preferably configured to be round, and have a diameter between 2 to 200 μm, preferably 5 to 200 μm, furthermore preferably 10 to 200 μm. In this connection, the first regions are separated from one another preferably at a distance between 5 to 1000 μm, preferably 10 to 1000 μm.

Preferably, substrates are used in which adjacent first regions are connected with one another by means of paths, along which neurites can form, whereby the width of these paths preferably lies between 100 nm and 10 μm.

The invention makes available a new protocol for measuring neurite growth:

The cells are first positioned on a substrate in an array pattern, and after a period of time, the number of viable cells in first regions and the neurite outgrowths are measured by means of a selection of possible methods, including the number of neurite outgrowths per viable cell, the number of neurite outgrowths and/or the neurite outgrowth rates. Cell samples can be treated with or without one or more test substances. If the cell samples are not exposed to a test substance, this provides an experimental control for the determination of the relative effects of one or more substances of interest.

Preferably, substrates are used in which the first regions contain one or more materials that promote cell adhesion, preferably cell adhesion proteins, such as laminin, fibronectin, collagen, or vitronectin, peptide sequences, polylysine, or other cell adhesion molecules or cell adhesion materials, such as hydrophilic polystyrene, glass, aminated surfaces, and hydrophilic polydimethylsiloxane (PDMS).

With regard to the second regions that prevent cell adhesion, substrates are used in which the second regions contain one or more materials that prevent cell adhesion, preferably polyethylene glycol, polyethylene oxide, agarose, albumin, polydimethylsiloxane (PDMS), polystyrene, and polyacrylamide.

The first regions of the substrate, in each instance, are preferably configured to be hydrophilic, and the second regions are preferably configured to be hydrophobic.

Preferably, it is provided that the paths consist of the same materials as the first regions or of different materials, which support neurite growth and either promote or do not promote cell adhesion.

Furthermore, the first regions can be an exposed surface of the substrate in question, which surface itself is a standard tissue culture substrate, including polystyrene, polypropylene, and glass. In this context, cell-repelling PDMS can be deposited or embossed onto standard tissue culture substrates, including polystyrene, polypropylene, and glass, as a thin film pattern.

Preferably, it is provided that the neurons or cells similar to neurons are analyzed on the array without fixation and staining. This way of using the method offers a particularly simple but effective possibility of determining neurite growth. The development of the network can thereby be analyzed periodically or even continuously. In this context, it is possible to analyze the functionality of the network, i.e. the connections between the neurons or cells similar to neurons, using live-imaging techniques, such as calcium imaging. Changes in the functionality of the network can be used as a further indicator of the effect of a test substance or other treatments.

In certain cases, however, it can alternatively be provided, that the neurons or cells similar to neurons are fixed in place on the substrate and/or that the neurons or cells similar to neurons are entirely or partially stained. These standard fixation methods include, for example, formaldehyde and glutaraldehyde methods; staining can take place, for example, with Giemsa or other total cell stains. In this context, parts of the neurons or cells similar to neurons can be stained, including their cell nuclei, their cytoskeleton or other cellular compartments, their neurite outgrowths or parts of their neurite outgrowths.

The stains can be fluorescent, whereby DAPI can be used for cell nucleus staining, phalloidin can be used for actin staining, and fluorescent molecules or particles that are bound to antibodies or aptamers can be used.

Neurite growth can be analyzed by means of one or more of the following measurements:

Connections between cells, number of neurites, number of cells that possess neurites, number of neurites per cell, neurite length, neurite growth rate, neurite branching, number of neurites per viable cell, or the rate of change of one or more of these parameters.

The measurements of neurite growth can be carried out continuously, periodically, or at the end of the exposure period of the treatment of the neurons or cells similar to neurons.

The substrate, in each instance, can be placed in a chamber for standard tissue culture or molecular analyses, including 6-, 12-, 24-, 96-, 384-, 1,536-well plates.

In this context, the chamber itself can be provided with first regions and second regions for adhesion or non-adhesion of neurons or cells similar to neurons, respectively, which correspond to the array pattern.

Supply or removal of fluids and, in particular, test substances can take place by means of pipettes, automated systems for handling fluids, or microfluidic systems.

Preferably, microchips with an array pattern can be used. Multiple array patterns can be applied to such a microchip, for example 5×5 arrays, each having 367 first regions.

The invention will be explained in greater detail below with respect to the accompanying drawing. The drawing shows, in a greatly enlarged manner, in schematic representation, in

FIG. 1 an array having a hexagonal arrangement of the first regions suitable for cell adhesion,

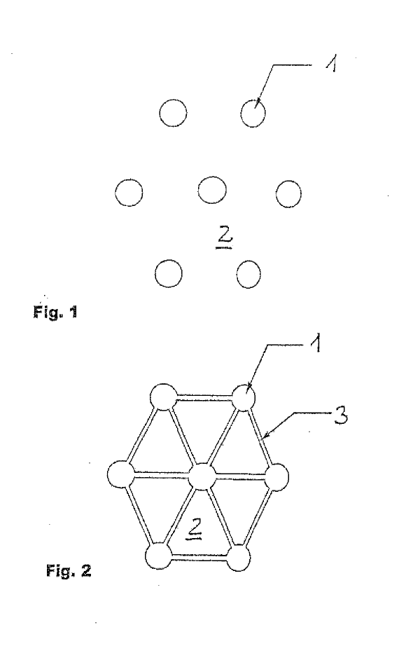

FIG. 2 an array similar to the one from FIG. 1, having first regions connected with one another by means of paths,

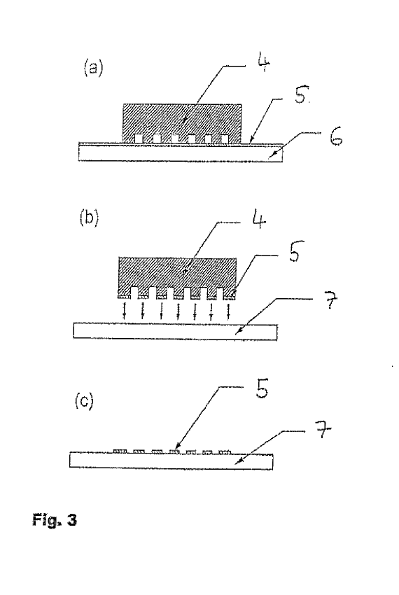

FIGS. 3a to 3c a method sequence for the production of arrays by means of micro-contact printing,

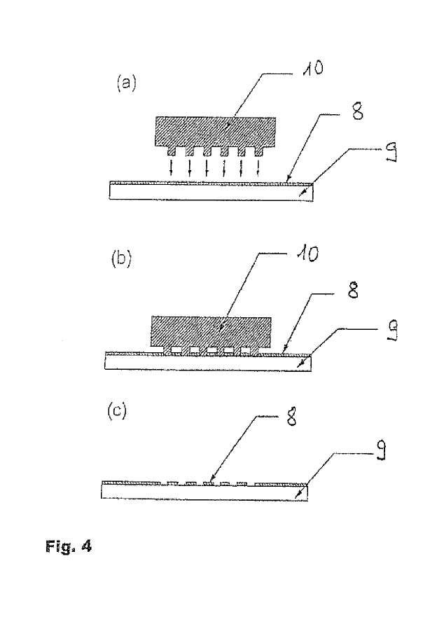

FIGS. 4a to 4c a method sequence for the production of an array by means of embossing technology,

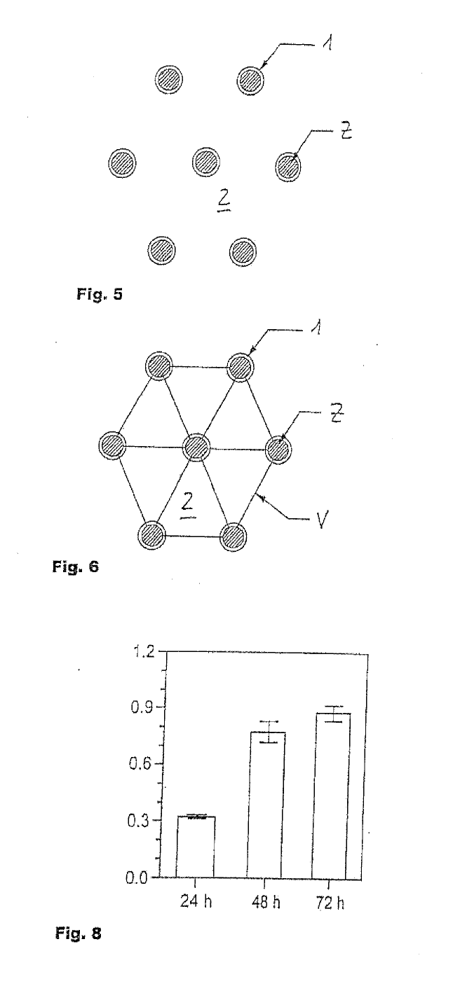

FIG. 5 an array having a hexagonal arrangement of the first regions, whereby each first region contains a neuron cell,

FIG. 6 an array according to FIG. 5, with an example of neurite growth,

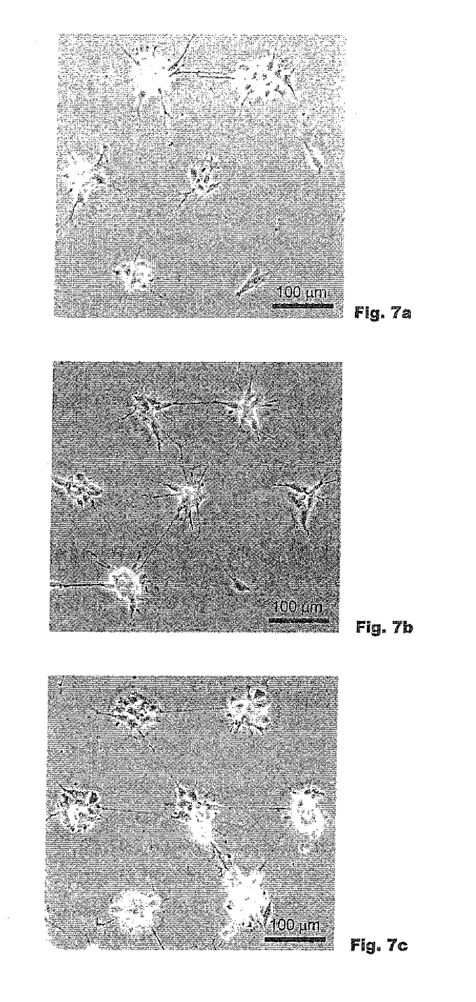

FIG. 7a, b, c images of differentiated human SH-SY5Y cells after 24, 48, and 72 hours, and in

FIG. 8 a plot of the number of connections per first region after 24, 48, and 72 hours.

In FIGS. 1 and 2, two different array types are shown, which have proven to be particularly suitable for implementing the method according to the invention.

In FIG. 1, an array is shown, which has first regions designated with 1, which are positioned hexagonally. These first regions 1 have a composition such that neurons and cells similar to neurons can adhere to them. These first regions 1 are equidistantly spaced, on the basis of the hexagonal arrangement, and are preferably configured to be round. They have a diameter, for example, between 5 to 200 μm, and are disposed at a distance from one another of 10 to 1000 μm. The first regions 1 are surrounded by second regions 2, which form the background of the patterned surface. These second regions 2 have a composition such that neurons and cells similar to neurons cannot adhere to them.

In FIG. 2, a substrate is shown that fundamentally corresponds to that according to FIG. 1; in other words, hexagonally positioned first regions 1 are provided, which are surrounded by second regions 2, in other words a patterned surface. Additionally, adjacent first regions 1 are connected with one another by means of paths 3, along which neurites can form. The width of these paths 3 is between 100 nm and 10 μm.

It is self-evident that a plurality of first regions 1 and second regions 2 are provided as arrays on a substrate. In FIGS. 1 and 2, only a single hexagonal arrangement is shown, in each instance, as an example. Typically, arrays are used that have a plurality of first regions 1, for example 367 first regions.

Such arrays can be positioned on microchips, for example 5×5 individual arrays can be positioned on a usual microchip.

There are many varied possibilities for the production of such arrays. In FIG. 3, a first method sequence is shown, namely the process of micro-contact printing patterns of thin film PDMS. For this purpose, a stamp 4 is contacted with a thin PDMS liquid film 5, which is transferred to a flat substrate, for example a glass substrate 6 (FIG. 3a).

The stamp 4, which is subsequently inked with the PDMS liquid film 5, is first removed and then contacted with a cell culture substrate 7 in order to transfer the PDMS liquid film 5 to the substrate 7 (FIG. 3b).

Subsequently, the stamp 4 is removed, and the pattern produced on the cell culture substrate 7 in this manner (second regions composed of PDMS) is thermally cured (FIG. 3c).

In this way, according to FIG. 3, cell-repelling hydrophobic materials are printed on hydrophilic substrates, such as glass or polystyrene, on which cells can usually adhere and grow. For this purpose, liquid PDMS was dissolved in chloroform (10:1, m/m), a volume of 500 μL was applied to the glass substrate 6 and spin-coated at 6000 rpm for 30 s. After evaporation of the chloroform, a uniform PDMS film layer 5 remains behind. Use of the stamp 4 with the liquid PDMS film 5 was achieved by means of contact of the stamp 4 with the thin film 5 for maximally 10 s. The stamp 4 inked with liquid PDMS was then used to transfer the PDMS film 5 onto substrates 7 composed of glass or tissue culture grade polystyrene for maximally 10 s. Afterwards, a curing step, at 70° C. for about 30 min was used to produce the thin-film pattern (array).

For a pattern with high resolution, excess PDMS is removed by means of a first contact imprint for maximally 10 s onto a so-called “sacrificial” glass substrate, followed by a second printing step, again for maximally 10 s, onto the cell culture substrate 7. A hexagonal arrangement of first regions 1 on the substrate, with uniformly distributed round first regions having typical diameters of 70 μm and distances of 100 μm between the individual cells can be achieved in this manner.

As an alternative to micro-contact printing, an embossing technique shown in FIG. 4 a to c can be used. First, as in the case of printing (FIG. 3), a thin film of PDMS 8 is deposited onto a substrate 9 composed of glass or polystyrene. The substrate is then placed onto a heating plate at approximately 70° C., and a stamp 10 is pressed against the substrate for about 1 min (pressure 0.15 Nmm⁻²) and then removed (FIG. 4b). This is followed by another step for thermal curing (about 10 min). This is shown in FIG. 4c.

The cells were seeded onto a substrate produced according to FIG. 1, either according to the method according to FIG. 3 or according to FIG. 4, in a medium that contains serum proteins, and incubated overnight. After replacement of the medium, adherent cells remained as a pattern, adhering the exposed regions of the underlying substrate. In order to illustrate the invention, human SH-SY5Y neuroblastoma cells are used, and differentiated into cells similar to neurons by means of cultivation in trans-retinoic acid for three days, before being seeded onto the array. As a result, an additional advantage was obtained for the experiment, by means of the synchronization of the cells. The neuron patterns were cultured, during which neurite growth occured, which in turn led to connections between the neurons of adjacent first regions (accumulation locations).

FIG. 5 shows the arrangement or adhesion of the cells similar to neurons on an array having a hexagonal arrangement of the first regions 1. In this connection, the cells similar to neurons are indicated with Z.

In FIG. 6, the neurite outgrowths or connections that connect the cells Z similar to neurons are shown and indicated with V.

The standardized arrangement of the first regions 1 as adhesion locations and the standardized for example uniform) length of the connections V between adjacent first regions 1 that form as the result of the neurite outgrowths can be seen. This simplifies the use of automated image processing techniques and neurite recognition, particularly their quantification. As a result, “high-content” screening of neuroactive substances is made possible.

The neurons or cells similar to neurons patterned on an array in this manner can be used to investigate substance effects on the growth of neurites. Model substances can be used to assess the suitability of the neuron patterns for measuring elevated or reduced growth rates. For example, nerve growth factor (NGF) promotes neurite growth, while acrylamide inhibits it. The experiments include patterning of neurons, followed by culture in the presence of substances of interest. Parallel to this, neuron patterns were cultured in normal medium, without these substances, in order to provide a control. After a culture period of two days, for example, the neurite outgrowths were measured (for example number of neurons that possess neurites and/or number of neurites per neuron). The measurements were carried out by means of phase-contrast microscopy, for example using an inverse microscope IX 71 from Olympus. The toxic or promoting effects can be determined by means of a comparison with the control sample. Furthermore, neuron patterns that are exposed to desired concentrations of the toxic or promoting model substances can serve as negative or positive controls.

The hexagonal arrangement of the first regions on the substrate allows unrestricted neurite growth and is ideally suited for observation of the formation of connections between the first regions. In FIGS. 7a to 7c, the development of an SH-SY5Y neuronal network over three days (after 24 hours, FIG. 7a; after 48 hours, FIG. 7b, and after 72 hours, FIG. 7c) is shown.

After 24 hours (FIG. 7a), a single connection can be seen, with multiple neurite outgrowths. After 48 hours (FIG. 7b), four neurite connections can already be seen, together with further enlarged neurite outgrowths.

Finally, FIG. 7c shows the status after 72 hours; seven neurite connections can be seen.

During a time period of three days, the number of neurite connections per adhesion first region has therefore grown from 0.32 to 0.88. This can be seen in FIG. 8, in which the number of neurite connections per occupied first region over time is shown.

1. Method for the analysis of neurite growth, in which a substrate having an array pattern is made available, which substrate has first regions having a standardized size and position, on which neurons and cells similar to neurons can adhere, whereby the first regions are surrounded by second regions, in each instance, on which neurons and cells similar to neurons cannot adhere, whereby neurons or cells similar to neurons adhere only on the first regions of the array, and subsequently, the neurons or cells similar to neurons are exposed to one or multiple or no treatment(s), and during this/these treatment(s) and/or afterwards, the neurite outgrowths from the neurons or cells similar to neurons are analyzed by recognizing and quantifying the connections that are formed between the first regions by means of the neurite outgrowths.

2. Method according to claim 1, wherein
the number of connections that exist between the first regions are counted.

3. Method according to claim 1, wherein
for treatment neurons or cells similar to neurons are exposed to one or more test substance(s) and/or test conditions(s).

4. Method according to claim 1, wherein
the first regions are spaced equidistant from one another.

5. Method according to claim 4, wherein
the first regions are positioned in a hexagonal pattern.

6. Method according to claim 4, wherein
the first regions are positioned in a linear or grid-like pattern.

7. Method according to claim 3, wherein
the first regions are round.

8. Method according to claim 7, wherein
the first regions have a diameter between 5 to 200 μm.

9. Method according to claim 4, wherein
the first regions are separated from one another by a distance of between 10 to 1000 μm.

10. Method according to claim 1, wherein
an array is used, in which the adjacent first regions are connected with one another by means of paths on which neurites can form.

11. Method according to claim 10, wherein
the width of the paths lies between 100 nm and 10 μm.

12. Method according to claim 1, wherein
an array is used in which the first regions contain one or more materials that promote cell adhesion, preferably cell adhesion proteins, such as laminin, fibronectin, collagens, or vitronectin, peptide sequences, polylysine, or other cell adhesion molecules or cell adhesion materials, such as hydrophilic polystyrene, glass, aminated surfaces, and hydrophilic polydimethylsiloxane (PDMS).

13. Method according to claim 1, wherein
an array is used, in which the second regions contain one or more materials that prevent cell adhesion, preferably polyethylene glycol, polyethylene oxide, agarose, albumin, polydimethylsiloxane (PDMS), polystyrene, and polyacrylamide.

14. Method according to claim 1, wherein
the first regions are hydrophilic, and the second regions are hydrophobic.

15. Method according to claim 10, wherein
the paths consist of the same materials as the first regions, or of different materials that support neurite growth and promote or do not promote cell adhesion.

16. Method according to claim 1, wherein
the neurons or cells similar to neurons adhere to the array and are subsequently analyzed without fixation and staining.

17. Method according to claim 1, wherein
the neurons or cells similar to neurons are fixed in place on the substrate by means of standard methods.

18. Method according to claim 1, wherein
the neurons or cells similar to neurons are entirely or partially stained.

19. Method according to claim 1, wherein
the neurite growth is analyzed by means of one or more of the following measurements:
connections between cells, number of neurites, number of cells that possess neurites, number of neurites per cell, neurite length, neurite growth rate, neurite branching, number of neurites per viable cell, or the rate of change of one or more of these parameters.

20. Method according to claim 1, wherein
the functionality of the connections between the neurons or cells similar to neurons is analyzed using live-imaging techniques.

21. Method according to claim 19, wherein
the measurements of neurite growth are carried out continuously, periodically, or at the end of the exposure period of the treatment of the neurons or cells similar to neurons.

22. Method according to claim 1, wherein
the array is placed in a chamber for standard tissue cultures or molecular analyses, including 6-, 12-, 24-, 96-, 384-, 1,536-well plates.

23. Method according to claim 22, wherein
the chamber for standard tissue culture or molecular analyses, including 6-, 12-, 24-, 96-, 384-, 1,536-well plates, is itself provided with first regions and second regions for adhesion or non-adhesion, respectively, of neurons or cells similar to neurons, corresponding to the array.

24. Method according to claim 22, wherein
fluids and test substances are supplied or removed by means of pipettes, automated systems for handling fluids, or microfluidic systems.

25. Method according to claim 1, wherein
microchips are used as substrates for the arrays.
